(19) United States
(12) Patent Application Publication
(10) Pub. No.: US 2009/0248240 A1
(43) Pub. Date: Oct. 1, 2009

(54) System for Measuring Lateral Gravitational Effect of Vehicles

(76) Inventors: Steven C. Olsen, Centennial, CO (US); Alex Nelsen, Castle Rock, CO (US)

Correspondence Address: GLENN L. WEBB;GLENN L. WEBB P.C., P.O BOX 3788, DURANGO, CO, 81302, US

(21) Appl. No.: 12/056,828

(22) Filed: Mar. 27, 2008

(51) Int. Cl. G06F 7/00

(52) U.S. Cl. 701/35; 701/29

(57) ABSTRACT

A system for measuring the lateral acceleration of a vehicle. The system includes an accelerometer that measures the lateral gravitational forces, an annunciator that announces the changes in the lateral gravitation forces, a data logging for storing the measured changes and the relative times and a controller. This system is particularly useful for training for performance driving such as racecar drivers and law enforcement drivers.

### FIELD OF THE INVENTION

This invention relates to the field of systems for measuring lateral acceleration of vehicles and particularly to a training system for performance driving.

### BACKGROUND OF THE INVENTION

Vehicles going through a corner, particularly at higher speeds, undergo acceleration in the lateral directions. Drivers and passengers often experience this experience, such as a tugging or pulling in lateral directions. This is due to the gravitation forces occurring due to the cornering of the vehicle. The gravitational forces experienced when cornering can be calculated from the radial acceleration formula where the acceleration equals the velocity of the vehicle squared multiplied by the radius of curvature of the corner.

The gravitational forces are typically expressed in meters/second² or more popularly, in terms of g-force. A g-force is the net effect of the acceleration that an object actually experiences and the acceleration that gravity is trying to impart to it. The g-force is referred to as a g which is a unit of acceleration equal to the Earth's gravity (9.81 m/s²).

A typical passenger car driver will experience up to 0.8 g while going through a sharp curve, performance sports cars may go up to 1.2 g while a Formula One driver may experience up to 2 g while cornering. If the lateral g-forces are sufficiently high, the threshold of friction between the tires of the vehicle may be exceeded, thus causing the vehicle to go out of control. Most typical passenger car drivers will thus slow when entering into a curve to minimize the g-forces during passage through corners.

One of the most critical factors of performance driving is the ability to maintain a high rate of speed while driving through a curve or corner. Most drivers tend to slow through a corner, thus their speed exiting the corner may not be optimum. The speed of the exit of the corner determines the speed during and at the end of the following straight away. The ability to maintain speed during a corner is one of the factors that distinguish successful performance drivers from less successful drivers. The appropriate level of lateral gravitation forces is a combination between the course conditions, the threshold of the tires, the set-up of the vehicle suspension and other factors and typically requires many hours of driving experience to understand these limits, if at all.

Currently, there are no training devices that will shorten the learning curve of driving through curves and corners at performance levels. This affects the performance and the safety level of those drivers, such as race car drivers, performance car enthusiasts, law enforcement officers and others who would like to learn to drive at performance levels.

There is a need for such a training device to improve safety of performance driving.

### SUMMARY OF THE INVENTION

The present invention provides a system for measuring the lateral gravitation forces of a vehicle in motion as well as a method for training drivers in performance driving. The system of the present invention measures the lateral gravitation forces of the vehicle and announces these measured g-forces to the driver without distracting the driver. This enables the driver to maintain the speed of the vehicle within safe limits.

A preferred embodiment of the present invention provides a device that includes an accelerometer. The accelerometer measures the changes in the lateral g-forces and announces those changes to the driver in increments. The driver can experiment to find the optimum level of g-forces that is comfortable or the optimum level can be predetermined by other drivers.

The present invention, in a preferred embodiment, provides an annunciator that announces the levels of the lateral g-forces to the driver. The annunciator also provides a digital recorder that allows prerecorded messages to be stored in the device to be announced to the driver at the moment of the appropriate lateral g-force.

The system of another preferred embodiment of the present invention provides a data logging module that stores the changes in the measured lateral g-forces as well as he relative times of the changes. These can be downloaded into an external computer for analysis.

The device of the system of a preferred embodiment can be easily mounted in a vehicle as well as removed for mounting in another vehicle. Further the device can be used for any object in motion, such as airplanes, boats, motorcycles, off-road vehicles and others.

The present invention in a preferred embodiment provides a method of training drivers. The method includes the steps of mounting the system in a vehicle and using the system to learn to maintain the speed of the vehicle while cornering or going through curves by staying with predetermined limits of lateral g-forces.

These and other features of the present invention will be evident from the ensuing detailed description of the preferred embodiments, from the drawings and from the claims.

### BRIEF DESCRIPTION OF DRAWINGS

FIG. 1 is a diagram of the components of a lateral gravitational sensing system of a preferred embodiment of the present invention.

FIG. 2 is a perspective diagram of the unit of the embodiment of FIG. 1.

### DETAILED DESCRIPTION OF PREFERRED EMBODIMENTS

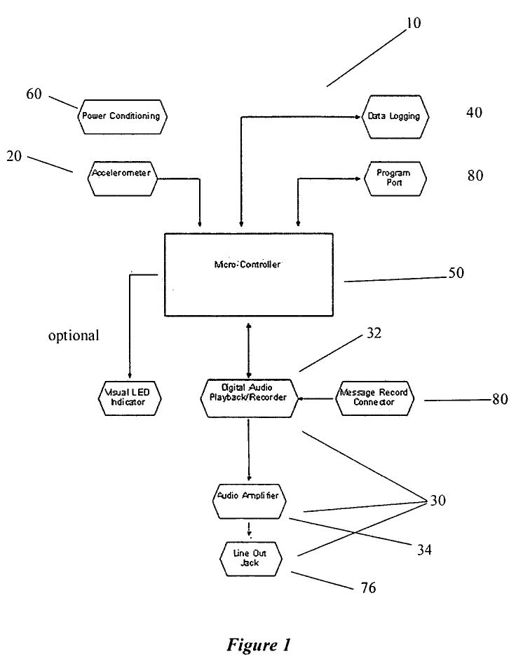

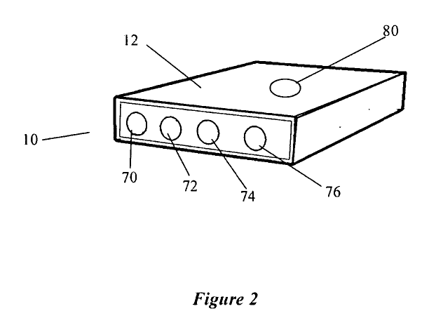

The present invention provides a system for measuring the lateral gravity forces during the operation of a vehicle. A preferred embodiment of this invention is illustrated in FIGS. 1-2. It is to be expressly understood that the descriptive embodiments are provided herein for explanatory purposes only and are not meant to unduly limit the claimed inventions. The exemplary embodiments describe the present invention in terms of an accessory item for a vehicle but can also be incorporated as original equipment in a vehicle. The system may also be used with any other situation where the lateral gravitational forces of an object is of interest. It is described for use with an automotive vehicle but may also be used with motorcycles, boats and other maritime vehicles, aviation uses and any other use where lateral acceleration may be of interest.

The system of a preferred embodiment of the present invention as shown in FIG. 2 is a self-contained unit 10. The unit 10 can be mounted permanently in a location in the vehicle, such as on a console, dashboard or on the ceiling of the vehicle. Preferably, the unit 10 is temporarily mounted by hook and loop attachment, clamp, clips or any other type of attachment mechanism.

### Overview

The unit 10 includes a number of components as described in the block diagram illustrated in FIG. 1. The unit 10 includes three primary components. The primary components include accelerometer 20, annunciator 30 and data logger 40. The operation of these components are controlled by micro-controller 50. The accelerometer 20 measures the lateral gravitational forces, the annunciator 30 signals the measured lateral gravitational forces to the vehicle driver and the data logger 40 logs the measured lateral gravitational forces for later recovery. The controller receives the measured gravitational forces from the accelerometer, conditions and provides the measured gravitational forces to the annunciator and to the data logger.

As the vehicle enters into a curve, the accelerometer 20 senses the increase in the lateral gravitational forces occurring in the vehicle. The increase is signaled to the driver through the annunciator 30 so that the driver can decrease their speed, maintain their speed or increase their speed accordingly. This can be extremely useful in training drivers of performance vehicles, such as race cars, police officers and other drivers operating vehicles at high speeds. The data can later be recovered for analysis as well.

### System Components

The accelerometer of the preferred embodiment of the present invention is dual (X-Y) axis accelerometer. This type of accelerometer measure the gravitational forces sustained during the motion and/or tilting of the vehicle. The accelerometer measures the acceleration of an object by measuring the net effect of the acceleration of the object. The measured units are typically expressed in meters/second² or more popularly, in terms of g-force. A g-force is the net effect of the acceleration that an object actually experiences and the acceleration that gravity is trying to impart to it. The g-force is referred to as a g which is a unit of acceleration equal to the Earth's gravity (9.81 m/s²). The g-force experienced when cornering can be calculated from the radial acceleration formula where the acceleration equals the velocity of the vehicle squared multiplied by the radius of curvature of the corner. A typical passenger car driver will experience 0.6 g to 0.8 g, performance sports cars will experience up to 1.2 g, while a Formula One driver will may experience up to 2 g while cornering.

In this preferred embodiment, the accelerometer 20 is a low-power two axes linear integrated chip accelerometer that includes a sensing element and an analog output. The accelerometer 20 measures the forward acceleration and deceleration as well as side to side lateral forces.

The annunciator 30 provides the signal to the driver relating to the measured output from the accelerometer. The annunciator may include audible and/or visual indicators. For example, the annunciator may provide audible alarms when the g-force has reached minimum and maximum levels or when the vehicle undergoes certain predetermined g-force levels. In this preferred embodiment, the annunciator begins to provide audible signals when the vehicle is experiencing 0.3 g and continues to announce the current g-force level at predetermined time intervals. The system announces the g-forces in 0.1 g increments ranging between 0.3 g up to 1.2 g. This range can be expanded or shortened as desired.

Also, in another preferred embodiment, the annunciator may also provide visual indicators, such as light emitting diodes (LEDs), heads-up displays or other light indicators. For example, a first LED may light up when the vehicle undergoes 0.3 g, a second LED may light up when the vehicle undergoes 0.4 g, etc. Different colors of lights could also be used to indicate the g-force level.

In this preferred embodiment, the annunciator 30 includes a digital audio playback/recorder 32. The digital audio playback/recorder 32 allows the operator to record their own preferred alerts subject to the appropriate g-force level. For example, the operator may leave a message that announces “3” at the 0.3 g level, “4 g” at the 0.4 g” level, and so on at other fractional g-force levels. Other messages may be used as well. The controller 50 will coordinate the correct message with the appropriate measured g-force measurement. Typically, in the preferred embodiment, the digital audio playback/recorder stores multiple announcement messages that are flashed into the memory of the device. Each message has a unique memory location that is queried by the controller at a specific time for annunciation of the current g-force. A microphone can be built in or else an input connector can be used to connect an external microphone to the recorder 32.

The annunciator 30, in this preferred embodiment, also includes an audio amplifier 34. The audio amplifier 34 is connected to an output jack 36. The output jack 36 can be connected to a headphone mounted in the helmet of the driver of the vehicle, or into an external input into the radio or stereo system of the vehicle. In one preferred embodiment, the output jack 36 can be connected to an FM wireless transmitter which will transmit the annunciated signal to the FM radio of the vehicle. This transmitter could also be integrated directly into the unit 10 in another preferred embodiment.

The data logger 40 records the data from the accelerometer and allows that recorded data to be transmitted via an external connection, such as a serial port or USB port connected to a personal computer. In this preferred embodiment, the data logger is a low power, bi-directional electronically erasable programmable read-only memory (EEPROM) chip. It is connected through the controller 50 to the accelerometer and to a serial port 80 for allowing the recorded data to be downloaded to an external device. The data logger stores the measured g-forces at both axes as well as the relative time of each measurement.

The controller 50 controls and coordinates the activity of the accelerometer, the annunciator and the data logger. In this preferred embodiment, the controller is a high performance, low power CMOS 8-bit microcontroller chip with programmable flash memory. The programming of the controller can easily be updated through connection to an external connector either separately from the voice recorder connection or in combination with the voice recorder connection.

The system includes converter power supply 60 to provide power to the electronic components of the system. The power supply 60 receives power from the vehicle electric battery through a cigarette style power cord at about 13.7 volts DC. This electric current is conditioned to the appropriate voltage to operate the electronics of the system, such as stepping the voltage down to a lower voltage as necessary to power the unit 10. Alternatively, an onboard battery power supply may be used.

The unit 10 includes a number of external features. In the preferred embodiment, unit 10 includes a front panel 12. The front panel 12 includes an electrical jack 70 for connection of the power supply 60 from the external power source. A LED 72 is also mounted on the front panel that signals whether the power is off or on, as well as whether the unit 10 has been calibrated. A calibration button 74 is also provided on the front panel as discussed below. Lineout jack 76 is provided on the front panel for connection between the annunciator and an external headphone or amplifier.

A data port 80 is provided on the upper surface of unit 10. The data port allows connection between the audio recorder and an external microphone, the data logger and an external computer and/or the microcontroller and an external computer. These connections may also be split between separate data ports as well.

The unit 10 is mountable to a vehicle by a bracket, by suction cups, by hook and loop fastening elements or any other type of fastening systems. It may be permanently mounted or temporarily mounted so to be usable for a variety of vehicles. It can also be mounted as original equipment during the manufacture of the vehicle. The unit 10 can be mounted in almost any location in the vehicle. It does not have to be absolutely horizontal. The calibration capability of the unit will compensate for some misalignment in the mounting of the unit.

In an alternative preferred embodiment, the unit 10 can include a wireless transmitter/receiver to operate the calibration feature of the unit as well as to transmit the annunciated signals. This will allow the unit to be mounted in a trunk, cargo compartment or other remote location on the vehicle. The wireless operation of the unit enables it to be operated without the need to physically be in contact with the unit.

The unit 10 has been described for use with an automotive vehicle but it may also have many other applications. For instance, it may be used in an airplane to monitor the acceleration during a banking maneuver, in a racing speedboat, motorcycle or any other type of moving object.

### Operation

Prior to operating the unit, the appropriate messages may be prerecorded in the annunciator 30. This is accomplished by the use of an external microphone plugged into data port 80 or through an external computer connected to the controller. The recorded messages are stored at specific locations that are accessed by the controller at the appropriate time. The firmware update and/or programming of the device can be done at this time as well.

The unit 10 is simple to set up and operate. A power cord is connected to the unit 10 through electrical jack 70. The unit is then attached at a desired location in the vehicle through the suction cups, hook and loop elements, bracket or other securing mechanism.

A headphone or wireless transmitter is then connected to the line out jack 76 of the unit. If a headphone is used, it may be a separate headphone or one integrated into a helmet worn by the driver. The unit is turned on by a power switch on the unit. The unit 10 is easily calibrated at this time. While the vehicle is motionless and not moving, the calibration button 74 is pressed, or if the unit is mounted in a remote location, the calibration is transmitted through a wireless operation. This will null out any positioning errors in the unit. The device may, if the message has been prerecorded, announce that the device has been “calibrated”. The device is ready for operation.

As lateral g-forces are incurred by the vehicle, the prerecorded messages announce those levels. A preset limit may be reached, if desired, before the messages begin. The use of audible specific messages are preferred over visual indicators so that the driver may remain focused on road before them instead of looking over at visual indicators. However, visual indicators may be used if desired.

The data may be retrieved from the unit 10 if desired through the data port 80 or other serial port connection outlet. This data indicates not only the g-forces that were measured but the time of the g-forces as well. This can be used to recreate the driving experience for training and evaluation purposes.

### Training Operations

One specific use of the unit 10 is for performance training of drivers. A critical factor that distinguishes between a successful racecar driver and one that is less successful is the ability to control their speed through a corner. The natural instinct of most drivers is to slow through a corner in order to maintain the control of the vehicle. This loss of speed through corners is often the difference between a winning driver and a losing driver. The alternative is to drive through the corners at an unsafe speed that does cause loss of control.

The unit of the present invention in a preferred embodiment provides a valuable training device for performance driving. The unit 10 will announce to the driver the lateral g forces that the vehicle is undergoing. The driver will be provided a safe range of lateral g-forces for that particular vehicle, depending on the course conditions, the threshold of the tires, the suspension set-up and other factors. This range may be previously determined by an experienced successful driver. The driver can then maintain the speed of the vehicle through these corners by staying beneath the threshold upper limit of the range of the lateral g-forces for that driver.

The unit of the preferred embodiment of the present invention may also be used for training other drivers that may need drive at performance levels. For example, police officers and other law enforcement officers, emergency first responders and others may be trained using the unit 10 to learn to drive swiftly but safely through traffic.

These and other features of the present invention are considered to be within the scope of the claimed inventions. The above descriptive embodiments are intended for explanatory purposes only and are not meant to limit the scope of the claimed inventions.

1. A system for measuring lateral gravitational forces during the operation of a vehicle, said system comprising:
an enclosure for mounting on to a vehicle;
a measuring sensor mounted within said enclosure for measuring lateral gravitational forces; and
an annunciator for annunciating the measured lateral gravitational forces from said measuring sensor.

2. The system of claim 1 wherein said measuring sensor includes:
an accelerometer.

3. The system of claim 1 wherein said measuring sensor includes:
a dual axis accelerometer.

4. The system of claim 1 wherein said system further comprises:
a micro-controller for receiving the signal from said measuring sensor and for controlling said annunciator.

5. The system of claim 1 wherein said system further comprises:
a logging module for logging the measured lateral gravitational forces from said measuring sensor.

6. The system of claim 1 wherein said logging module includes:
an EEPROM chip.

7. The system of claim 1 wherein said annunciator includes:
an audible signal generator that provides an audible indication of the gravitational forces.

8. The system of claim 1 wherein said system further comprises:
a line out for connection to an external speaker system.

9. The system of claim 1 wherein said annunciator includes:
an audible recorder to allow annunciation messages to be pre-recorded for playback.

10. The system of claim 1 wherein said annunciator includes:
a visual signal generator.

11. The system of claim 1 wherein said annunciator includes:
a calibration module for calibrating the accuracy of said measuring sensor.

12. A method for training for performance driving wherein said method comprises:
providing a system for measuring lateral gravitational forces having a sensor for measuring lateral gravitational forces and an annunciator for annunciating the measured lateral gravitational forces from said measuring sensor;
mounting said system in the vehicle;
determining the safe range of lateral g-forces for operation of the vehicle;
sensing the lateral g-forces with said system;
listening to the annunciation of said sensed lateral g-forces; and
driving the vehicle within said determined safe range of lateral g-forces.

13. The method of claim 12 wherein said method further comprises:
training drivers for racing performance vehicles.

14. The method of claim 12 wherein said method further comprises:
training drivers for law enforcement purposes.

15. The method of claim 12 wherein said method further comprises:
training drivers for emergency purposes.

16. The system of claim 12 wherein said measuring sensor includes:
an accelerometer.

17. The system of claim 12 wherein said measuring sensor includes:
a dual axis accelerometer.

18. The system of claim 12 wherein said system further comprises:
a micro-controller for receiving the signal from said measuring sensor and for controlling said annunciator.

19. The system of claim 12 wherein said system further comprises:
a logging module for logging the measured lateral gravitational forces from said measuring sensor.

20. The system of claim 1 wherein said annunciator includes:
an audible signal generator that provides an audible indication of the gravitational forces.

21. The system of claim 1 wherein said system further comprises:
a line out for connection to an external source.

22. The system of claim 1 wherein said annunciator includes:
an audible recorder to allow annunciation messages to be pre-recorded for playback.

23. The system of claim 1 wherein said annunciator includes:
a visual signal generator.

24. The system of claim 1 wherein said annunciator includes:
a calibration module for calibrating the accuracy of said measuring sensor.
